(19) United States
(12) Patent Application Publication
(10) Pub. No.: US 2011/0129607 A1
(43) Pub. Date: Jun. 2, 2011

(54) Substitutional electroless gold plating solution and method for forming gold plating layer using the same

(75) Inventors: Kwi Jong LEE, Suwon (KR); Dong Hoon KIM, Seongnam (KR); Young Kwan SEO, Suwon (KR)

(73) Assignee: SAMSUNG ELECTRO-MECHANICS CO., LTD., Suwon-si (KR)

(21) Appl. No.: 12/801,758

(22) Filed: Jun. 23, 2010

(30) Foreign Application Priority Data
Dec. 1, 2009 (KR) 10-2009-0117640

(51) Int. Cl. B05D 5/00; C09D 5/00

(52) U.S. Cl. 427/287; 106/1.05

(57) ABSTRACT

There is provided a substitutional electroless gold plating solution and a method for forming a gold plating layer using the same. The substitutional electroless gold plating solution includes an organic solvent, and an organic acid-based gold salt dissociated from the organic solvent to generate gold ions. The substitutional electroless gold plating solution can form a gold plating layer having a uniform thickness and enhance bonding strength with a base metal. Further, the substitutional electroless gold plating solution can form a gold plating layer using various printing methods.

### CROSS-REFERENCE TO RELATED APPLICATIONS

This application claims the priority of Korean Patent Application No. 10-2009-0117640 filed on Dec. 1, 2009, in the Korean Intellectual Property Office, the disclosure of which is incorporated herein by reference.

### BACKGROUND OF THE INVENTION

1. Field of the Invention

The present invention relates to a substitutional electroless gold plating solution and a method for forming a gold plating layer using the same, and more particularly, to a substitutional electroless gold plating solution that can form a gold plating layer having a uniform thickness and a method for forming the gold plating layer using the same.

2. Description of the Related Art

In general, a substitutional electroless gold plating solution has been used in forming a thin film in an electronic component. A plating coated part of the electronic component to which substitutional plating is subject has been joined to other electronic components by soldering, etc. during a mounting process, which have been finally combined to an electronic apparatus such as a personal computer, a mobile phone, etc.

Recently, as electronic apparatuses have become smaller and lighter, the soldering characteristics of the substitutional gold plating have become increasingly important. In order to meet the demand for smaller and lighter electronic apparatuses, solder-joined parts have themselves become smaller and there is increasing opportunity for these small parts to be exposed to mechanical impact, compression or deforming pressure as electronic apparatuses have become ever more portable. In order to prevent electronic circuits from being disconnected, there has been a demand for stronger soldering junction strength than that of the prior art.

Substitutional gold plating has been mainly used in preventing a base metal (for example, copper, nickel, cobalt, palladium, etc.) from being corroded and securing wetness at the time of soldering melt. However, if substitutional gold plating is not properly performed, soldering junction strength is lowered. In other words, when substitutional gold plating is not properly performed, oxidation occurs in the base metal and when the surface of the gold plating is joined by soldering, an adhesive layer between the base metal and the soldering does not have sufficient strength.

The gold thin film formed on the base metal is diffused into the inside of the soldering at the time of soldering melt, and an interface alloy layer is soldered with a metal to be plated.

The substitutional gold plating, which is a gold plating method using a difference in ionization drift between gold and a base metal in a plating solution, ionizes gold, the most difficult metal to ionize, and melts it in the plating solution. When a substrate installed with the base metal is dipped in the plating solution as a substrate to be plated, the base metal having large ionization drift is ionized to be melted in the plating solution and gold ions in the plating solution are precipitated onto the base metal as a metal, thereby forming a gold coating. The substitutional gold plating method as described above does not require a reducing agent.

Meanwhile, electroless plating that requires the reducing agent is known as reduced plating and is used in a case requiring a thickness thicker than that in the substitutional gold plating.

Japanese Patent Laid-Open Publication No. 2001-144441 discloses an electroless plating solution that includes a complexing agent which does not melt a base metal and a gold precipitation-preventing agent suppressing excessive etching of the base metal as indispensable components in the plating solution.

However, although the Japanese Patent Laid-Open publication aims to suppress the excessive etching of the base metal, it does not consider anti-oxidation of the base metal. Further, when the complexing agent not melting the base metal is used, the base metal eluted by a substitution reaction cannot be stably melted, the base metal can be easily reprecipitated together with gold, and the original hue of the gold cannot be obtained as the obtained gold plating develops a brown hue.

### SUMMARY OF THE INVENTION

An aspect of the present invention provides a substitutional electroless gold plating solution that can control a substitution reaction speed and corrosion speed of a base metal and provide a uniform thickness of a gold plating layer and excellent bonding strength thereof, and a method for forming the gold plating layer using the same.

According to an aspect of the present invention, there is provided a substitutional electroless gold plating solution including: an organic solvent; and an organic acid-based gold salt dissociated from the organic solvent to generate gold ions.

The organic acid-based gold salt may be at least one selected from a group consisting of halides-based gold salt, acetylacetonate-based gold salt, and acetate-based gold salt.

The organic solvent may be at least one selected from a group consisting of alcohol, glycol, and ether.

The organic solvent may be at least one selected from a group consisting of methanol, ethanol, propanol, iso-propanol, butanol, pentanol, hexanol, ethylene glycol, propylene glycol, diethylene glycol, triethylene glycol, poly(propylene glycol), diethyl ether, dipropylene glycol metyl ether, dipropylene glycol diacetate, and diethylene glcyol methyl ether.

According to another aspect of the present invention, there is provided a method for forming a gold plating layer, including: preparing a substrate on which a metal pad is formed; applying a substitutional electroless gold plating solution including an organic solvent and an organic acid-based gold salt dissociated from the organic solvent to generate gold ions on the metal pad; and forming a gold plating layer according to substitution between the metal and the gold ions.

The applying of the substitutional electroless gold plating solution may be performed by a printing method.

The metal pad may be made of copper, nickel, cobalt or palladium.

The organic acid-based gold salt may be at least one selected from a group consisting of halides-based gold salt, acetylacetonate-based gold salt, and acetate-based gold salt.

The organic solvent may be at least one selected from a group consisting of alcohol, glycol, and ether.

The organic solvent may be at least one selected from a group consisting of methanol, ethanol, propanol, iso-propanol, butanol, pentanol, hexanol, ethylene glycol, propylene glycol, diethylene glycol, triethylene glycol, poly(propylene glycol), diethyl ether, dipropylene glycol metyl ether, dipropylene glycol diacetate, and diethylene glcyol methyl ether.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic plan view showing a portion of a substrate on which a gold plating layer is formed according to an exemplary embodiment of the present invention; and

FIG. 2 is a schematic cross-sectional view showing a substrate taken along line I-I′ of FIG. 1.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and sizes of elements may be exaggerated for clarity. Like reference numerals in the drawings denote like elements.

The present invention relates to a substitutional electroless gold plating solution. The substitutional electroless gold plating solution according to an exemplary embodiment of the present invention includes an organic solvent and an organic acid-based gold salt dissociated by the organic solvent and generating gold ions.

The substitutional electroless gold plating solution, according to an exemplary embodiment of the present invention, uses an organic solvent rather than an aqueous solvent, in contrast to electroless gold plating solutions according to the prior art.

In general, when gold salt melted with water is reacted with a base metal such as copper, nickel, cobalt, palladium, etc., gold fiercely reacts with the base metal, thereby forming a gold plating layer in a short period of time. However, the gold plating layer formed in a short period of time does not have a uniform thickness, and its bonding strength with the base metal becomes weak.

The substitutional electroless gold plating solution, according to an exemplary embodiment of the present invention, controls the substitution reaction speed between gold and the base metal and prevents the base metal from being corroded due to the use of the organic solvent. Therefore, a gold plating layer having a uniform thickness can be formed, and the bonding strength with the base metal can be enhanced. Further, the substitutional electroless gold plating solution, according to an exemplary embodiment of the present invention, does not include water, thereby making it possible to form the gold plating layer by various printing methods.

Each component of the substitutional electroless gold plating solution, according to an exemplary embodiment of the present invention, will now be described in greater detail.

The substitutional electroless gold plating solution, according to an exemplary embodiment of the present invention, includes an organic acid-based gold salt. The exemplary embodiment of the present invention uses gold salt including an organic acid salt as the organic acid-based gold salt, but is not limited thereto. For example, the exemplary embodiment of the present invention uses halides-based gold salt, acetylacetonate-based gold salt or acetate-based gold salt, or a mixture of one or more thereof.

The concentration of the organic acid-based gold salt may be, for example, 0.001 to 1.0M, but is not limited thereto.

When the concentration is below 0.001M, the thickness of the formed gold plating film is too thin to prevent the base metal from being oxidized, and when the concentration exceeds 0.1M, it is difficult to form the gold plating film having a uniform thickness as well as the bonding strength between the plating film and the base metal is lowered.

In the prior art, an aqueous solvent is used so that a cyanide-based gold salt or a sulfate-based gold salt which is aqueous gold salt is used. However, in the exemplary embodiment of the present invention, an organic solvent is used so that various sorts of organic acid-based gold salt may be used.

The substitutional electroless gold plating solution according to an exemplary embodiment of the present invention uses an organic solvent as a solvent dissociating the organic acid-based gold salt. Although water may be naturally added, the main solvent thereof is the organic solvent.

The organic solvent is used, thereby making it possible to control the substitution reaction speed between the gold ions and the base metal and the corrosion speed of the base metal. Further, the viscosity and the surface tension of the substitutional electroless gold plating solution, according to the exemplary embodiment of the present invention, can be easily controlled.

The organic solvent that can be used in the present invention is not limited to the above-mentioned components and therefore, alcohol, glycol, ether, etc. or a mixture of one or more thereof may be used.

As for the alcohol, it may, for example, be methanol, ethanol, propanol, iso-propanol, butanol, pentanol, hexanol, etc.

As for the glycol, it may, for example, be ethylene glycol, propylene glycol, diethylene glycol, triethylene glycol or poly(propylene glycol).

As for the ether, it may, for example, be diethyl ether, dipropylene glycol metyl ether, dipropylene glycol diacetate or diethylene glcyol methyl ether.

The substitutional electroless gold plating, which is a gold plating method using a difference in ionization drift between gold and the base metal, ionizes gold, the is most difficult metal to ionize and melts it in plating solution. When a substrate on which the base metal is formed is dipped in the plating solution, the base metal having large ionization drift is ionized to be melted in the plating solution and gold ions in the plating solution are precipitated onto the base metal as a metal, thereby forming a gold coating.

At this time, the substation reaction between gold and the base metal is generally fiercely performed in water. Therefore, a gold plating layer is formed in a short period of time and the gold plating layer has a non-uniform thickness and low bonding strength with the base metal.

The prior art includes a complexing agent stabilizing gold ions so as to control the substitution reaction speed and not melt the base metal, thereby controlling the substitution reaction speed.

On the contrary, the substitutional electroless gold plating solution according to an exemplary embodiment of the present invention includes the organic solvent, thereby making it possible to lower the substitution reaction speed between gold and the base metal. The substitutional electroless gold plating solution, according to an exemplary embodiment of the present invention, is able to control reactivity by using the organic solvent alone, without any separate additive.

Therefore, the gold plating layer having a uniform thickness can be formed and the gold plating layer having improved bonding strength with the base metal can be formed.

The substitutional electroless gold plating solution according to an exemplary embodiment of the present invention can include an additive for controlling pH or viscosity, etc. as needed, in addition to the components as described above. As for the additive, it may, for example, be a fatty amine, an ammonium salt or an acetylacetonate, etc.

According to another aspect of the present invention, there is provided a method for forming a gold plating layer using the substitutional electroless gold plating solution.

The substitutional electroless gold plating solution according to an exemplary embodiment of the present invention includes an organic acid-based gold salt and an organic solvent, but does not substantially include water. Therefore, a gold plating layer may be formed using a printing method.

A method for forming a gold plating layer according to an exemplary embodiment of the present invention will now be described with reference to the accompanying drawings. The exemplary embodiments of the present invention may be modified in many different forms and the scope of the invention should not be limited to the embodiments set forth herein. Further, the exemplary embodiments of the present invention are provided so that those skilled in the art to which the present invention pertains can fully understand the present invention. In the drawings, the shape and the size of the device may be exaggerated for the convenience. Like reference numerals designate like components throughout the specification.

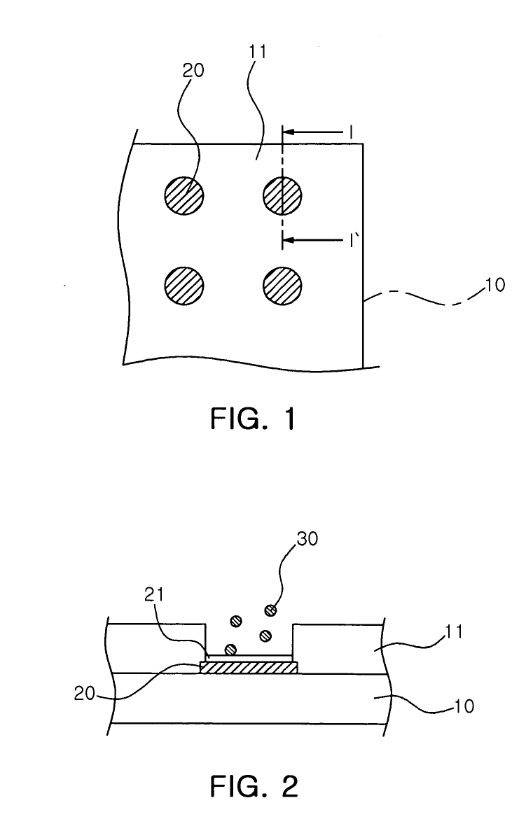

FIG. 1 is a schematic plan view showing a portion of a substrate on which a gold plating layer is formed according to an exemplary embodiment of the present invention, and FIG. 2 is a schematic cross-sectional view showing a substrate taken along line I-I′ of FIG. 1.

Referring to FIGS. 1 and 2, metal pads 20 are arranged on a substrate 10 to be plated, and a protective layer 11 formed with opening portions in order to expose the metal pads 20 is formed on the substrate.

As for the metal for forming the metal pad 20, any metal having a larger ionization drift than gold may be used without special limitation. For example, copper, nickel, cobalt or palladium may be used.

A nickel coating 21 that can be easily substituted with gold ions may be formed according to the sorts of the metal pad 20.

A substitutional electroless gold plating solution 30, according to an exemplary embodiment of the present invention, is applied on the metal pad 20 or the nickel coating 21 exposed through the opening portion. The exemplary embodiment of the present invention may apply the plating solution by a printing method by way of example, but is not limited thereto. Therefore, an inkjet printing method, a screen printing method, a flexographic printing method, a gravia method, an offset printing method, etc. may be used.

As described above, the substitutional electroless gold plating solution according to the present invention includes the organic solvent and the organic acid-based gold salt that is dissociated from the organic solvent to generate gold ions.

The substitutional electroless gold plating solution includes the organic solvent, such that the viscosity and the surface tension thereof can be easily controlled.

The viscosity of the substitutional electroless gold plating solution can be controlled according to the used printing method.

When the substitutional electroless gold plating solution is applied on the metal pad 20 or the nickel coating 21, a substitution reaction between the metal or the nickel and the gold ions is performed.

The metal or the nickel having larger ionization drift than gold is ionized to be melted in the plating solution and gold ions in the plating solution are precipitated on the metal pad, thereby forming a gold plating layer.

In general, the electroless plating is performed by filling the plating solution including aqueous gold salt in a plating bath and dipping a substrate to be plated in the plating solution. This process may cause a high defect rate in the gold plating layer when the plating bath is polluted, such that the plating bath is required to be closely monitored.

Further, the gold plating layer may be formed on an undesired region, such that the loss rate of the plating solution is high.

Further, a method using ink including metal nano particles or an organic metal complex is used so as to form a metal thin film. Metal ink is applied and then sintered on a desired region, thereby forming a metal thin film.

However, this method has a sintering temperature generally higher than a decomposition temperature of a substrate, such that the substrate may be damaged during the sintering process. Further, the volume of the ink is reduced during the sintering process, such that a difference in thickness may occur in the metal thin film. Further, ink may be applied on the undesired region.

To the contrary, according to exemplary embodiments of the present invention, the substitution reaction speed between gold and metal forming the metal pad can be slowed. Therefore, the gold plating layer having a uniform thickness can be formed and the gold plating layer having excellent bonding strength with the metal pad can be formed.

Further, the gold plating solution can be applied only on the desired region using a printing method, thereby making it possible to reduce loss of the gold plating solution.

Further, according to exemplary embodiments of the present invention, the substitution reaction with the gold ions is not performed, despite being printed on the substrate rather than the metal pad, such that the gold plating layer is not formed. In other words, although the gold plating solution is applied on a non-targeted region, it can be easily removed by cleaning using water or a solvent.

Further, according to exemplary embodiments of the present invention, a high-temperature heat treatment is not necessary to form the gold plating layer, such that the substrate is not damaged.

As set forth above, according to exemplary embodiments of the invention, the substitutional electroless gold plating solution can control the substitution reaction speed between gold and the base metal and prevent the base metal from being corroded using the organic solvent. Therefore, a gold plating layer having a uniform thickness can be formed and bonding strength with the base metal can be enhanced. Further, the substitutional electroless gold plating solution does not include water, such that the gold plating layer can be formed using various printing methods.

Further, when the gold plating layer is formed using the printing method, the gold plating solution can be applied only on a desired region, thereby making it possible to reduce the loss of the gold plating solution.

While the present invention has been shown and described in connection with the exemplary embodiments, it will be apparent to those skilled in the art that modifications and variations can be made without departing from the spirit and scope of the invention as defined by the appended claims.

What is claimed is:

1. A substitutional electroless gold plating solution, comprising:
an organic solvent; and
an organic acid-based gold salt dissociated from the organic solvent to generate gold ions.

2. The substitutional electroless gold plating solution of claim 1, wherein the organic acid-based gold salt is at least one selected from a group consisting of halides-based gold salt, acetylacetonate-based gold salt, and acetate-based gold salt.

3. The substitutional electroless gold plating solution of claim 1, wherein the organic solvent is at least one selected from a group consisting of alcohol, glycol, and ether.

4. The substitutional electroless gold plating solution of claim 1, wherein the organic solvent is at least one selected from a group consisting of methanol, ethanol, propanol, iso-propanol, butanol, pentanol, hexanol, ethylene glycol, propylene glycol, diethylene glycol, triethylene glycol, poly(propylene glycol), diethyl ether, dipropylene glycol metyl ether, dipropylene glycol diacetate, and diethylene glcyol methyl ether.

5. A method for forming a gold plating layer, comprising:
preparing a substrate on which a metal pad is formed;
applying a substitutional electroless gold plating solution including an organic solvent and an organic acid-based gold salt dissociated from the organic solvent to generate gold ions on the metal pad; and
forming a gold plating layer according to substitution between the metal and the gold ions.

6. The method for forming the gold plating layer of claim 5, wherein the applying of the substitutional electroless gold plating solution is performed by a printing method.

7. The method for forming the gold plating layer of claim 5, wherein the metal pad is made of copper, nickel, cobalt or palladium.

8. The method for forming the gold plating layer of claim 5, wherein the organic acid-based gold salt is at least one selected from a group consisting of halides-based gold salt, acetylacetonate-based gold salt, and acetate-based gold salt.

9. The method for forming the gold plating layer of claim 5, wherein the organic solvent is at least one selected from a group consisting of alcohol, glycol, and ether.

10. The method for forming the gold plating layer of claim 5, wherein the organic solvent is at least one selected from a group consisting of methanol, ethanol, propanol, iso-propanol, butanol, pentanol, hexanol, ethylene glycol, propylene glycol, diethylene glycol, triethylene glycol, poly(propylene glycol), diethyl ether, dipropylene glycol metyl ether, dipropylene glycol diacetate, and diethylene glcyol methyl ether.
